(19) United States
(12) Patent Application Publication
(10) Pub. No.: US 2002/0065743 A1
(43) Pub. Date: May 30, 2002

(54) Product ordering system

(75) Inventors: Cary Lee Bates, Rochester, MN (US); Steven Lee Harrington, Austin, TX (US); Jeffrey Michael Ryan, Byron, MN (US)

Correspondence Address: Robert V. Wilder, Attorney at Law, 4235 Kingsburg Drive, Round Rock, TX, 78681, US

(73) Assignee: International Business Machines Corporation

(21) Appl. No.: 09/726,271

(22) Filed: Nov. 30, 2000

(51) Int. Cl. G06F 17/60

(52) U.S. Cl. 705/27; 705/26; 705/39; 705/40

(57) ABSTRACT

A method and implementing TV system are provided in which, software products, which may be associated with a TV commercial being played, are presented to viewers in connection with the related commercial. In an exemplary embodiment, a menu screen is presented and viewers are enabled to select a “purchase” option associated with a software product. The software product may be downloaded, after purchase, in the “background” to the purchaser while the purchaser views the next segment of a TV program, or the software may be downloaded to the viewer's set prior to the presentation of the commercial for faster delivery and subject to later deletion if the software is not ordered by the viewer within a given time period associated with the presentation of the commercial.

### FIELD OF THE INVENTION

The present invention relates generally to information processing systems and more particularly to a methodology and implementation for ordering software in conjunction with the presentation of related TV programs.

### BACKGROUND OF THE INVENTION

The expanding use of computer systems, both in businesses and in homes, is being driven by the development of highly sophisticated computer programs. While the sale and distribution of the computer systems themselves is relatively straight forward, the methodology for the sale and distribution of related software programs remains a difficult task. In most cases, potential software program users typically must purchase a software program before the user is able to see the program operate, or learn more about the program than is presented on the outside cover of the program.

Even with the growth of the Internet, users must still proactively log-on to the Internet, and “go” to a site where they may be able to find out more about the program that they may be interested in purchasing. Frequently, a potential purchaser will see an ad for a software product on a television (TV) commercial, and if more information is needed, they are directed to a website on the World Wide Web. The potential purchaser will then go to a computer, logon the Internet and go to the designated web site. Even in this situation, however, the purchase of software is not finished. If the potential purchaser decides to purchase the software, the purchaser must then enter purchasing information including the purchaser's charge card number, expiration date of the card and additional personal information. After all of the credit information has been checked and approved, the software will be sent to the purchaser by mail or other delivery service, or possibly downloaded to the purchaser's computer. Even if the program can be delivered by downloading, the entire purchase and delivery process is both tedious and complicated.

Thus, there is a need for an improved method and implementation for facilitating the presentation and purchase of software products.

### SUMMARY OF THE INVENTION

A method and implementing TV system are provided in which, software products, which may be associated with a TV commercial being played, are presented to viewers in connection with the related commercial. The TV system includes means coupled to the TV by which viewers are given an opportunity to purchase designated software products through direct interaction with the TV. In an exemplary embodiment, a menu screen is presented and viewers are enabled to select a “purchase” option associated with a software product. Since the information necessary for the purchase transaction is on file with the video service provider, the viewer is enabled to order the software product with minimum input. The software product may be downloaded, after purchase, in the “background” to the purchaser while the purchaser views the next segment of a TV program, or the software may be downloaded to the viewer's set prior to the presentation of the commercial for faster delivery and subject to later deletion if the software is not ordered by the viewer within a given time period associated with the presentation of the commercial.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary TV system including various components;

FIG. 2 is a schematic diagram of the TV set-top box shown in FIG. 1;

FIG. 3 is a time line illustrating a first exemplary operation of the disclosed methodology;

FIG. 4 is a time line illustrating a second exemplary operation of the disclosed methodology;

FIG. 5 is a flow chart illustrating an exemplary purchase sequence in connection with the present invention;

FIG. 6 is a flow chart illustrating an exemplary operational sequence of the present invention;

FIG. 7 is a continuation of the flow chart of FIG. 6;

FIG. 8 is a flow chart illustrating an exemplary processing technique in connection with the present invention; and

FIG. 9 is a continuation of the flow chart of FIG. 8.

### DETAILED DESCRIPTION

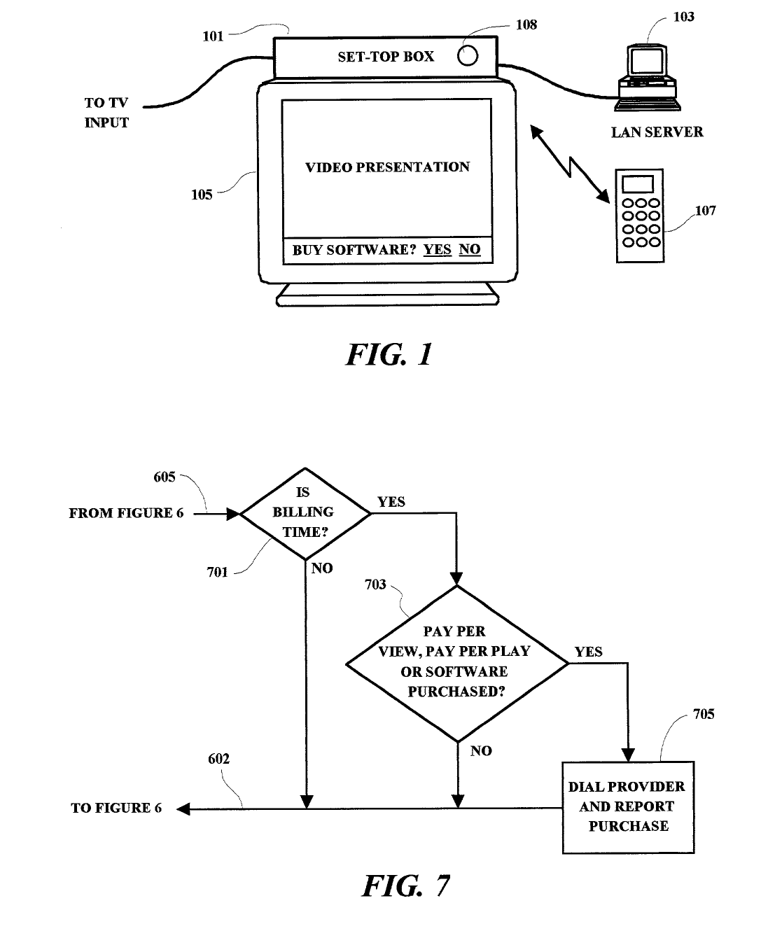

The various methods discussed herein may be implemented within an exemplary TV system which, as shown in FIG. 1, includes a TV set 105 and a control set-top control box 101. The set-top box 101 in the example is connected to a local area network (LAN) server 103 and is also connected to receive a TV input. The TV input may be connected to a cable system or directly to a TV dish receiver or other input system. Also shown in FIG. 1 is a remote control device 107 which is used to provide user input to the TV unit 105. The remote unit in the present example is an infrared (IR) device which communicates with the set-top box through an IR sensor 108 located on the box 101. Other user input systems, such as touch-screen or joy stick input devices may also be used. The LAN server 103 is generally known in the art and is not presented here in any further detail in order not to obfuscate the disclosure of the present invention. The TV set 105 is shown as displaying a video presentation in which a portion of the display is designed to enable a user, through the use of the remote unit 107, to purchase a software product which associated with the displayed presentation as is discussed in more detail in connection with the subsequent flow charts.

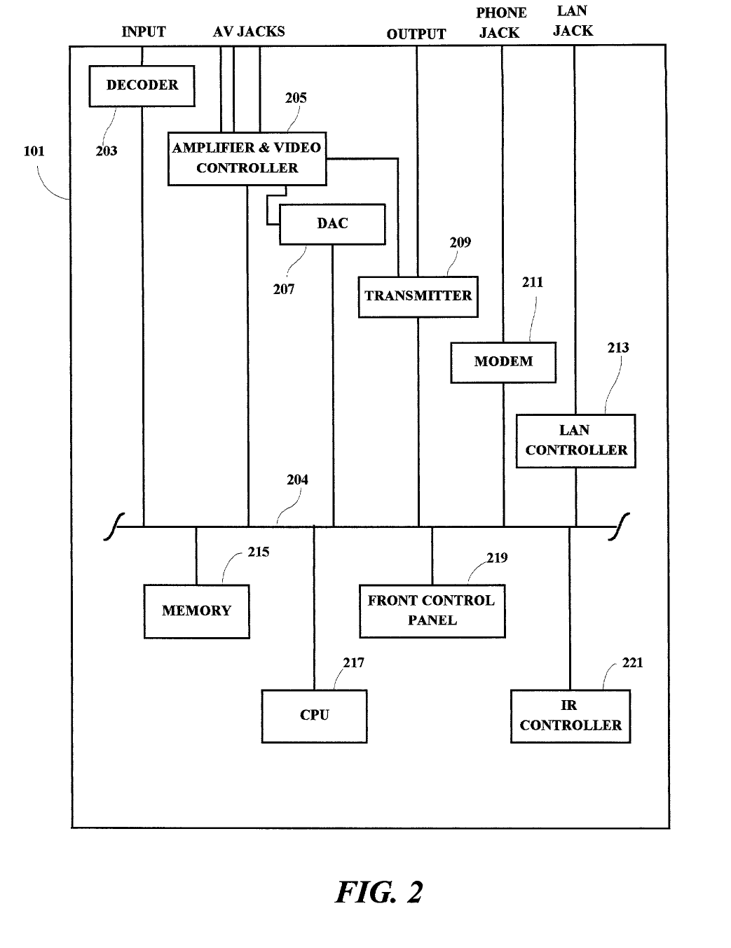

The contents of the set-top box 101 are shown in more detail in FIG. 2. As shown, the input is connected through a decoder 203 to a main bus 204. Audio/visual (AV) jacks are connected through an amplifier and video controller 205 to the bus 204. The AV jacks are arranged for being selectively connected to the TV 105. A digital-to-analog converter (DAC) 207 is arranged to receive inputs from the amplifier and video controller 205. The DAC 207 is also connected to the bus 204. A transmitter 209 is arranged to be selectively connected to the TV unit 105 through an OUTPUT terminal of the set-top box 101. The transmitter unit 209 is connected to the main bus 204 and also receives an input from the amplifier 205. A modem 211 and a LAN controller 213 are also separately connected between the bus 204 and respective output terminals of the set-top box 101. As shown, the bus 204 is also connected to memory device 215, at least one CPU 217, the front control panel 219 and an IR controller 221 which is used in connection with the remote control unit 107. The set-top box may include additional devices connected to the main bus 204 to enhance performance or provide additional functional capability.

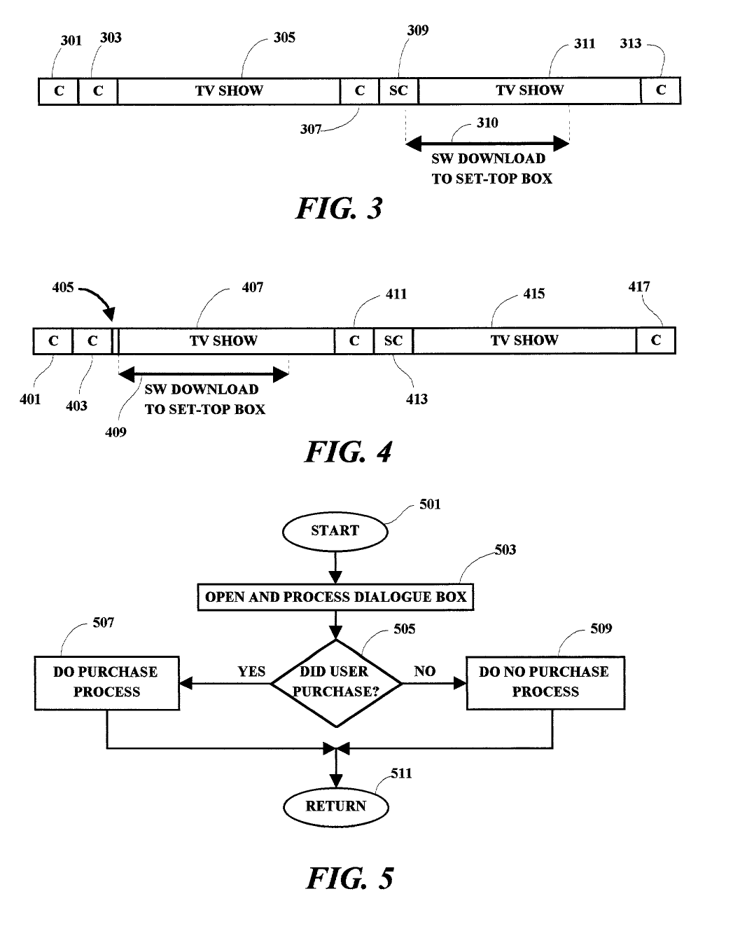

The time line shown in FIG. 3 illustrates one possible operational sequence using the present invention. As shown, a TV unit would display two commercials (“C”) 301 and 303, followed by the presentation of a TV show or program 305. Other commercials 307, 313 may also be presented in accordance with normal programming practices. The TV show or program in the example, may be an animated show with animated characters. In addition, a sponsor may have merchandise items such as toys, which could be presented in one or more of the commercial breaks. In the exemplary set-top environment, the user has an existing account with the TV signal provider (cable or satellite dish or other) and processes billing the account, for providing the TV input content, periodically such as every month. In this case, the subscriber's name and address are known to the content provider so that the regular monthly billing may also include billing for items which may be ordered by the user during the billing period. This billing process may also be done automatically through a pre-approved credit card or bank debit arrangement. This arrangement obviated the need for the user to provide extensive personal information for each related purchase of an item advertised on the user's TV set as herein described.

In another example, the TV show could be a so-called “infomercial” which explains and demonstrates the use of a software program, or the TV show may be another program that has software program merchandise associated with the show. As shown, one of the commercial segments is a software commercial (SC) 309. During the SC 309, material and dialogue are presented to the user and the user is enabled, through the use of an input device such as a remote control unit 107, to interact with the set-top or control box 101 in response to the dialogue presented during the software commercial, to indicate whether the user wishes to purchase software or other items advertised for sale during the software commercial 309. If the advertised item is a software program, the advertised software may be downloaded 310 to the user's memory 215 or to an associated LAN server 103, with the download running in parallel with the continuing presentation of the TV show 311.

The embodiment illustrated in FIG. 4 is similar to that illustrated in FIG. 3, and includes commercials 401, 403 411 and 417, as well as TV show segments 407 and 415, except that, upon detection of a predetermined signal on the input data stream 405, software associated with an upcoming software commercial 413 is automatically downloaded ahead of time 409. Then, when the associated software commercial is presented 413, the actual software program is already available at the user unit. This will enable faster processing. Also, more than one order for more than one software program may be processed with additional orders being placed at the time of the software commercial. Only those additional orders will need to be downloaded following the software commercial 413 since the primary software program was pre-downloaded 409 prior to the commercial SC 413. As discussed in connection with the following flow charts, if the software is pre-downloaded 409 and the user does not order the software program during, or within a predetermined time period following the presented software commercial 413, then the downloaded program can be erased from the memory in which the downloaded program was stored. As shown in FIG. 5, a high level flow begins 501 by opening and processing 503 a purchase-related dialogue box to be displayed to the user. The program then determines if the user has purchased the advertised software product 515. The purchase, in the present invention, is made very simple and may include, for example, only a single “click” on the remote controller 107 which is made by the user during the presentation of the software commercial. As hereinbefore noted, the account and billing procedures are already established with the content provider so that no further additional personal or charge-related information needs to be provided at order time. If the purchase was made, a “purchase” bit is set to a “TRUE” condition, and the “purchase” processing is accomplished 507. If the software product was not purchased during the commercial, or within a predetermined time period following the commercial, then the “purchase” bit is set to be “FALSE”, the “no purchase” process is accomplished 509 and the program returns 511 to await another activation by a subsequent software commercial.

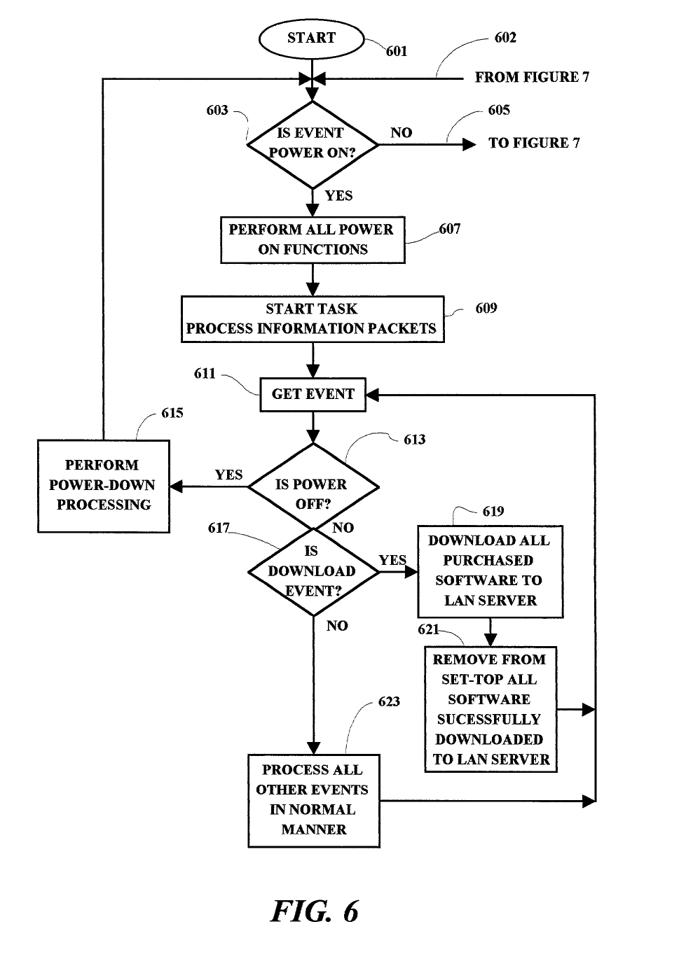

As shown in FIG. 6, in one processing example, when the methodology begins 601 and initially determines if the event or TV power is being, or was just turned “ON” 603. If not, the process continues 605 to process a billing routine as is hereinafter explained in connection with FIG. 7. If the TV power is determined to have been switched “ON”, then all power-on functions are performed 607 and the TV information “packets” of data which are received at the input to the set-top control box 101 begin to be processed 609. Next, when an input is received from a user through the remote unit 107 for example, an indicated event is acquired 611. The input from the user may be any of several input commands including a mere changing of channels. The changing of channels by the user is significant since different programs having different software commercials are presented. If the power for the set-top box is switched “OFF” 613, power-down processing is performed 615 and the process returns to detect the next “power-on” condition 603. If the power to the set-top box is “ON”, it is determined if there is a download event 617, for example, if a software product was purchased. If there is a download event 617, then all purchased software is downloaded 619 and after the downloaded software is stored to a designated user memory such as an associated LAN server 103, all software temporarily stored in the set-top box memory 215 is removed 621 and the process returns to detect the next event 611. If the event is not a download event 617, then all other events are processed in a normal manner 623 before returning to detect the next event 611. The download event could also be initiated on server 103, which would cause all purchased software on the set-top box 101 to be downloaded to the server 103. In a home environment, server 103 will likely not be “ON” when the software is purchased so after the show or feature presentation, a viewer would go to the computer 103 and download the software.

As shown in FIG. 7, when it is detected that the TV is not powered-on 603, the process continues 605 to the billing method illustrated in FIG. 7. As shown in FIG. 7, when it determined to be billing time 701, it is then determined, for each billing event, whether or not the event was a pay-per-view event, a pay-per-play event or a software purchase event 703. If any of those or other designated purchase events have occurred, then the content provider is dialed and the purchase is reported 705, and the process returns 602 to FIG. 6. The provider may then bill the user in the next regular invoice for the purchases made during the period. If no purchase events have been logged at billing time 703, then the process also returns 602 to FIG. 6 and the content provider, for example, does not bill the user for any purchased items but only for the normal monthly use of the TV input.

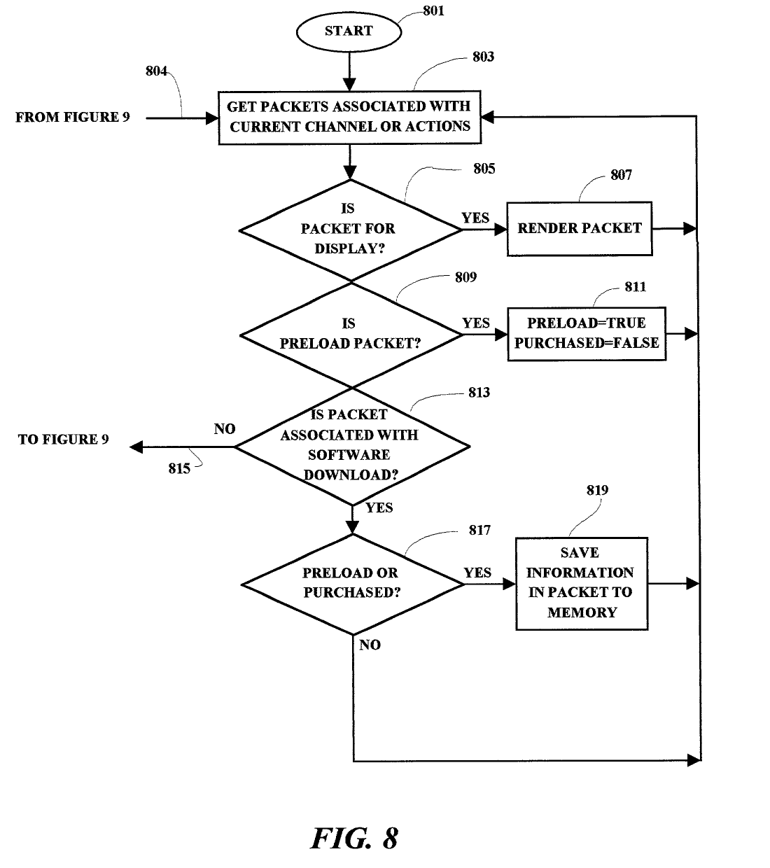

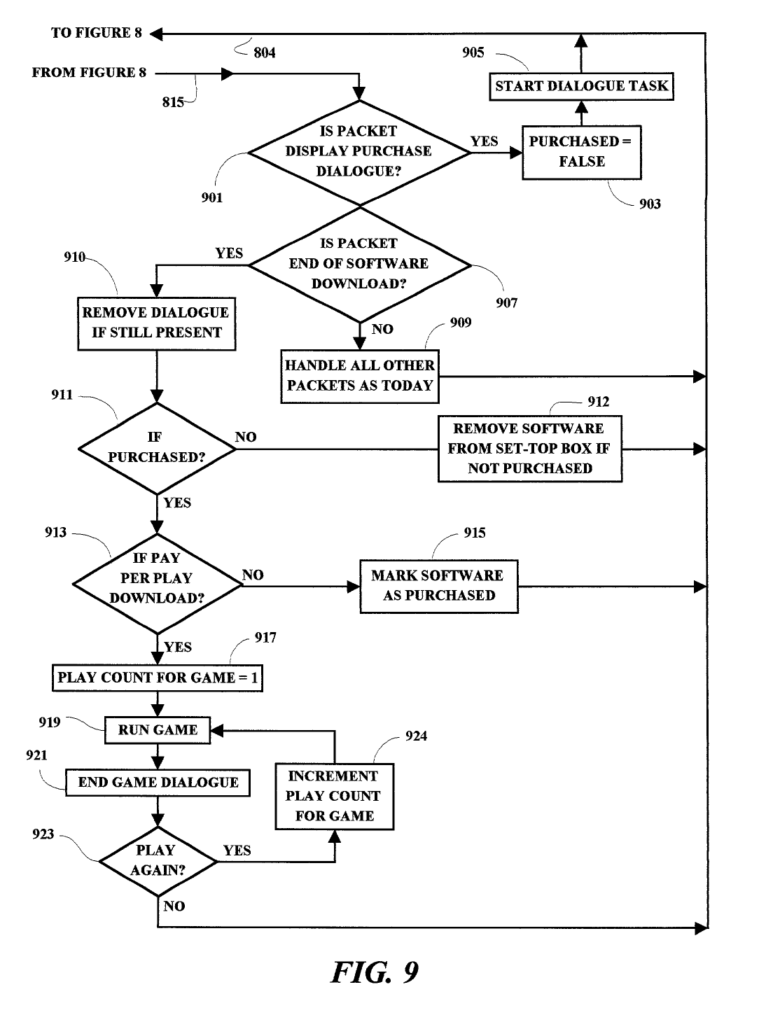

The “process Information Packets” block 609 in FIG. 6 is illustrated in more detail in FIG. 8. As shown, the processing starts 801 and retrieves packets 803 associated with the current channel or other action from the user. If the packet is coded for a display 805, then the display is rendered 807 and returned to detect the next input 803. If the packet is a pre-load packet 809 (for example as described in connection with FIG. 4), then a “PRELOAD” condition bit is set to be “TRUE” and a “PURCHASED” condition bit is set to be “FALSE”. Next, if the packet is not associated with a software download 813, then the process returns 815 to FIG. 9. However, if the packet is not a pre-load packet 809 and is associated with a software download 813, then it is determined if the pre-load or a purchase bit is TRUE 817. If either the pre-load or purchase bit is TRUE 817, then the information in the packet is saved to designated memory 819 and the process returns to block 803. If the preload and purchase bits are FALSE 817, the process returns directly to block 803.

If the packet is not associated with a software download 813, the processing continues 815 as shown in FIG. 9. As shown, it is determined if the packet is a purchase display dialogue 901, and if so, the “PURCHASE” bit is set to “FALSE” 903, the dialogue task is started 905 and the process returns 804 to block 803 of FIG. 8. If the packet is not a display purchase dialogue 901, then it is determined if the packet indicates an end of software download condition 907. If it is not the end of a software download, all other packets are handled “as today” and the processing returns 804 to block 803 in FIG. 8.

In FIG. 9, when the packet indicates an end-of-software download condition 907, then the dialogue is removed if still present 910 and a determination is made if software has been purchased 911. If not, the process removes the software from the set-top box 912 and returns 804 to block 803. If, however, it is determined that the software has been purchased 911, then, if it is not a pay-per-play item 913, the software is marked as “purchased” (Purchase bit set to TRUE) 915, and the process returns to block 803. If the purchase is a “pay-per-play” or game item 913, then a play count is set to “1” 917 and the game is run 919. When the game has completed for example, an “End Game” dialogue is presented 921. If the user desires to play the game again 923, then the play count is incremented 924 and the game is run again 919. When the user indicates through the user's remote unit that the user no longer wishes to play the game 923, then the processing returns 804 to FIG. 8. A record is saved of the number of plays, and at billing time 701, the user is billed for the number of plays recorded.

The method and apparatus of the present invention has been described in connection with a preferred embodiment as disclosed herein. The disclosed methodology may be implemented in many different ways in order to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may be implemented partially or totally in program code stored on one of many possible media carriers, or other memory device, from which it may be accessed and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling product sales for products associated with a user display screen presentation to a viewer, said method comprising:
providing a presentation signal to a viewer, said presentation signal being selectively operable to effect a presentation on a display screen of a viewer, said presentation including interactive commercial segments for presenting products available for purchase;
receiving a purchase input from said viewer within a predetermined time period following a beginning of one of said commercial segments, said purchase input indicating a viewer command to purchase a selected one of said products; and
storing indicia representative of said purchase in a first designated user memory location.

2. The method as set forth in claim 1 and further including:
periodically reading said designated user memory location by a provider of said presentation signal;
detecting said indicia; and
processing said purchase in response to detecting of said indicia.

3. The method as set forth in claim 2 wherein said processing includes effecting a delivery of products specified by said purchase.

4. The method as set forth in claim 1 and further including billing said viewer by said provider of said presentation signal in response to said purchase input.

5. The method as set forth in claim 4 wherein said billing further includes:
getting stored purchase inputs for a billing period;
determining a first charge for purchases corresponding to said stored purchase inputs;
determining a second charge for providing said presentation signal for a corresponding period of time; and
combining said first charge and said second charge to provide a total charge for said corresponding period of time, said total charge being billed to said viewer by said provider of said presentation signal.

6. The method as set forth in claim 1 wherein said products are software program products.

7. The method as set forth in claim 6 and further including:
downloading at least one of said software program products to a second designated user memory location.

8. The method as set forth in claim 7 wherein said downloading of said software program products is accomplished prior to a presentation of a related one of said interactive commercial segments.

9. The method as set forth in claim 8 wherein said presentation includes feature segments separate from said interactive commercial segments, and wherein said downloading of said software program products is accomplished during a feature segment of said presentation.

10. The method as set forth in claim 7 wherein said downloading is accomplished in response to said purchase input made by said viewer.

11. The method as set forth in claim 10 wherein said presentation includes feature segments separate from said interactive commercial segments, and wherein said downloading of said software program products is accomplished during a feature segment of said presentation.

12. The method as set forth in claim 6 wherein said software program products comprise products for which payment is determined in accordance with a number of times a purchased product is played by said viewer, said method further including maintaining a memory of said number of times said purchased product is played during a billing cycle.

13. The method as set forth in claim 7 wherein said software program products are transferred from said second designated user memory location to a persistent storage memory location after a purchase of said software program product is made by said viewer.

14. The method as set forth in claim 13 wherein said software program product is deleted from said second designated user memory location after said software program product has been transferred to said persistent storage memory location.

15. A storage medium including machine readable coded indicia, said storage medium being selectively coupled to a reading device, said reading device being selectively coupled to processing circuitry, said reading device being selectively operable to read said machine readable coded indicia and provide program signals representative thereof, said program signals being effective for enabling product sales for products associated with a user display screen presentation to a viewer, said program signals being selectively operable to accomplish the steps of:
monitoring a presentation signal being provided to a viewer display screen, said presentation signal being selectively operable to effect a presentation on said display screen, said presentation including interactive commercial segments for presenting products available for purchase;
receiving a purchase input from said viewer within a predetermined time period following a beginning of one of said commercial segments, said purchase input indicating a viewer command to purchase a selected one of said products; and
storing indicia representative of said purchase in a first designated user memory location.

16. The medium as set forth in claim 15 wherein said program signals are further effective for enabling a billing to said viewer by said provider of said presentation signal in response to said purchase input.

17. The medium as set forth in claim 16 wherein said billing further includes:
getting stored purchase inputs for a billing period;
determining a first charge for purchases corresponding to said stored purchase inputs;
determining a second charge for providing said presentation signal for a corresponding period of time; and
combining said first charge and said second charge to provide a total charge for said corresponding period of time, said total charge being billed to said viewer by said provider of said presentation signal.

18. The medium as set forth in claim 17 wherein said products are software program products.

19. The medium as set forth in claim 18 wherein said program signals are further effective for:
downloading at least one of said software program products to a second designated user memory location.

20. The medium as set forth in claim 19 wherein said downloading of said software program products is accomplished prior to a presentation of a related one of said interactive commercial segments.

21. The medium as set forth in claim 20 wherein said presentation includes feature segments separate from said interactive commercial segments, and wherein said downloading of said software program products is accomplished during a feature segment of said presentation.

22. The medium as set forth in claim 19 wherein said downloading is accomplished in response to said purchase input made by said viewer.

23. The medium as set forth in claim 22 wherein said presentation includes feature segments separate from said interactive commercial segments, and wherein said downloading of said software program products is accomplished during a feature segment of said presentation.

24. The medium as set forth in claim 18 wherein said software program products comprise products for which payment is determined in accordance with a number of times a purchased product is played by said viewer, said program signals being further effective for maintaining a memory of said number of times said purchased product is played during a billing cycle.

25. The medium as set forth in claim 19 wherein said software program products are transferred from said second designated user memory location to a persistent storage memory location after a purchase of said software program product is made by said viewer.

26. The medium as set forth in claim 25 wherein said software program product is deleted from said second designated user memory location after said software program product has been transferred to said persistent storage memory location.

27. An information processing system comprising:
a display device;
a control unit connected to said display device, said control unit including input terminal means arranged for receiving an input signal from a display signal provider, said display signal being selectively operable for providing a presentation on said display device, said presentation being comprised of interactive commercial segments and separate feature segments, said interactive commercial segments being designed for presenting software products available for purchase;
a user input device arranged to interact with said control unit, said user input device being selectively operable for providing user input to said control unit related to said interactive commercial segments whereby a user is enabled to indicate a purchase command to said control unit to purchase one or more of said products during one of said interactive commercial segments, said control unit further including means responsive to said purchase command for downloading a software product corresponding to said purchase command through said input terminal means to a first user memory location during one of said separate feature segments of said presentation on said display device.

28. The information processing system as set forth in claim 27 and further including means for downloading said software program product to said control unit prior to a presentation of a related one of said interactive commercial segments.
